(19) United States
(12) Patent Application Publication
(10) Pub. No.: US 2025/0193297 A1
(43) Pub. Date: Jun. 12, 2025

(54) METHOD AND DEVICE FOR MANAGING AN UPDATE OF AN END DEVICE IN A TELECOMMUNICATION NETWORK

(71) Applicant: SAGEMCOM BROADBAND SAS, Bois-Colombes (FR)

(72) Inventor: Olivier PAYEN, Bois-Colombes (FR)

(73) Assignee: SAGEMCOM BROADBAND SAS, Bois-Colombes (FR)

(21) Appl. No.: 18/959,299

(22) Filed: Nov. 25, 2024

(30) Foreign Application Priority Data
Dec. 7, 2023 (FR) 2313772

(51) Int. Cl. H04L 69/24

(52) U.S. Cl. CPC H04L 69/24

(57) ABSTRACT

Disclosed is a method and system for managing an update of an end device communicating with a controller device via a current communication protocol. The method may be implemented by the end device and may include storing in memory a first part of another communication protocol different from the current communication protocol, using said first part for: sending a probe message specific to said other communication protocol, awaiting at least one response message, checking whether at least one said response message is received and downloading a second part of said other communication protocol so as to have available a complete version of said other communication protocol. This method further includes a phase of updating the end device with said other communication protocol as a new current communication protocol.

### TECHNICAL FIELD

The present disclosure relates to the field of telecommunication networks, for example wireless telecommunication networks. In particular, the present disclosure relates to the management of an update of a communication protocol of an end device belonging to a local communication network. More specifically, the present disclosure relates to updating the protocol stack of the end device according to the communication protocol currently used by a controller device managing the local communication network.

### PRIOR ART

A wireless communication network (hereinafter “communication network”) in accordance with one of the IEEE 802.11 standards (for example one or more of amendments b, g, a, n, ac, ax, be, etc of IEEE 802.11) typically comprises a plurality of nodes. Each node is an electronic device comprising at a minimum a radio-frequency module for establishing communications in accordance with one of the IEEE 802.11 standards, or in other words in accordance with of the Wi-Fi standards. Such a communication network is for example a local communication network LAN (standing for “Local Area Network”), for example a home network or professional network.

Some local communication networks LAN comprise, for example, systems for extending wireless communication coverage typically comprising one or more electronic devices, commonly called access points (“AP”), and a plurality of so-called user (or client) electronic devices (hereinafter “user devices”) able to establish wireless connections with one of the access points and/or with each other. These various access points are interconnected by means of a backhaul subnetwork and all make available to user devices one and the same wireless local area network WLAN. These access points are for example wireless extenders. The user devices are typically computers, televisions, TV set-top boxes, etc. It is thus commonly said that user devices are associated “in Wi-Fi” with the access points. Hereinafter, the access points and the user devices are called “end devices”.

Among the electronic devices, one may be a so-called “controller” device since the other end devices in the local communication network LAN are dependent on its control. This may be the case in a wireless communication network of the mesh type wherein one of the access points centralises certain decisions on configuration of the other access points. In one example, the controller device decides on the communication protocol used for the exchanges of the end devices with each other or with a home gateway, in the local communication network LAN. In one example, in a residential, or professional, environment, the controller device can be integrated in a “box” supplied by an internet operator, i.e. the home or professional gateway.

The home, or professional, gateway is connected to the wide area network (WAN), such as for example an internet network, by ADSL (“Asymmetric Digital Subscriber Line”) copper connection, or similar, by fibre and/or by mobile access of the 3G/4G/5G type, enabling the end devices of the network to access the wide area network WAN and to communicate with each other.

In the local communication network LAN, the communication protocol (e.g. communication protocol according to the Easy-Mesh standard, etc) used by all the various end devices to communicate with each other or with the home gateway for access to the wide area network WAN, is therefore managed by the controller device. Thus, in general, the communication protocol used by the end devices at an instant t corresponds to the one used at the same instant by the controller device. Hereinafter it is considered that the communication protocol used in the local communication network LAN corresponds to the one used by the controller device.

When the communication protocol of the controller device is updated (i.e. update of its protocol stack), then the end devices communicating via the old version of the communication protocol of the controller device can no longer communicate with each other or with the gateway for access to the wide area network WAN for example. Their protocol stack must then also be updated.

In order to be able to adapt dynamically to the modifications to the communication protocol of the controller device, the end devices can comprise several protocol modules each having their own communication protocol. To discover, or detect, which communication protocol is being used by the controller device at the instant t, the end devices can sequentially activate each embedded communication protocol. Alternatively, the end devices can simultaneously activate all the embedded communication protocols in order to detect the communication protocol currently being used by the controller device.

Sequential or simultaneous activation of all the embedded communication protocols has the major drawback of great complexity of operation, in particular for simultaneous activation. Furthermore, in order to support the multiple communication protocols, the end devices must comprise sufficient hardware resources, in particular with regard to the storage space.

However, some old or low-cost end devices do not necessarily have these hardware resources for the cohabitation of several protocol modules, each accommodating its own communication protocol. Thus, when the communication protocol currently being used must change (for example following an update of the protocol stack of the controller device or when a new more recent controller device is integrated in the local communication network LAN), it is often necessary to manually act on these end devices to update them. This task may be particularly complicated for a user and cause a prolonged interruption of the services offered by the end devices.

It is therefore desirable to overcome these drawbacks of the prior art.

### DISCLOSURE

It is desirable to provide a solution that makes it possible to simplify the updating of the protocol stack of the end devices, when the communication protocol used by the controller device managing the local communication network is different from the one currently used by the end device.

For these purposes, a method is proposed here for managing an update of an end device belonging to a local communication network managed by a controller device, the end device communicating with the controller device via a current communication protocol. The method is implemented by the end device, and comprises:
storing in memory a first part of another communication protocol different from the current communication protocol,
executing a discovery phase during which the end device uses said first part for:
sending, to the controller device, at least one probe message specific to said other communication protocol,
awaiting at least one response message responding to the at least one probe message sent, coming from the controller device,
checking whether at least one said response message is received and then downloading a second part of said other communication protocol, complementary to said first part, so as to have available a complete version of said other communication protocol,
executing a phase of updating the end device comprising: replacing, in the end device, the current communication protocol with said other communication protocol as a new current communication protocol.

Thus the present disclosure proposes an entirely novel and inventive approach to managing the updating of an end device (e.g. wireless extender, set-top box, etc).

More particularly, the present disclosure proposes updating the protocol stack of the end device of a local communication network, by means of storing and executing a first specific part of a new communication protocol different from the one currently being used by the controller device managing the local communication network.

Using this first specific part of the new communication protocol makes it possible to detect whether this new communication protocol is being used by the controller device managing the local communication network (for example following the updating of the protocol stack of this controller device).

The use by the controller device of the new communication protocol is detected by means of the sending of a probe message specific to the new communication protocol and the reception of a response message in return. Thus, when the new communication protocol replaces the current communication protocol in the local communication network, then a second part complementary to the first part of the new protocol is downloaded, to obtain the complete version of this new communication protocol. It is then possible, for the end device, to execute the whole of the new communication protocol.

It is thus possible to easily implement the updating of the protocol stack of the end device, without manual intervention.

Moreover, it is furthermore possible to optimise a storage space, such as a memory of the end device, since there is only a specific part of the new communication protocol that is stored in memory. It is thus possible to store several “partial” communication protocols (i.e. several specific parts of several communication protocols), different from the one currently being used by the controller device managing the local communication network.

According to one embodiment, the phase of updating the end device furthermore comprises deleting from the end device the current communication protocol that has become obsolete.

Advantageously, it is thus possible to optimise the storage space, or memory, of the end device by storing only the new communication protocol supported by the local communication network (i.e. the communication protocol used by the controller device managing the local communication network). In particular, it is possible to release storage space by deleting the current communication protocol that has become obsolete, which is then replaced by the new communication protocol.

According to one embodiment, the probe message is sent repeatedly and the second part of the other communication protocol, complementary to the first part, is downloaded if, over a predefined period, a number of response messages received is greater than or equal to a predefined reliability threshold.

Advantageously, the use by the controller device of the new communication protocol is detected by means of the repeated sending of the probe message specific to the new communication protocol and the reception of a number of reliable response messages in return. A response message is considered to be reliable when the number of response messages is greater than or equal to a predefined reliability threshold.

According to one embodiment, the probe message sent is sent in a broadcast transmission.

Advantageously, in the case where the local communication network comprises a plurality of controller devices, it is thus possible to address all these controller devices.

According to one embodiment, the probe message is sent at a predefined transmission frequency.

It is thus possible to limit the period of interruption of the services in order not to interfere with the users, while not degrading the network performances.

According to one embodiment, the predefined transmission frequency is between 1 second and 5 minutes.

According to one embodiment, the method furthermore comprises storing in memory a list of a plurality of other communication protocols, different from the current communication protocol, said other communication protocols being classified in an order of communication protocol from the most recent to the least recent, and, for each other communication protocol in the list, storing in memory a first part of said other communication protocol in question, and wherein the discovery phase, during which the first part of each said other communication protocol is used, is executed in the order of said list.

Advantageously, when a plurality of controller devices are connected to the local communication network at the same time and use different communication protocols (i.e. one of the communication protocols of a controller device being more recent than another communication protocol of another controller device), it is possible to hierarchise, in a list, these communication protocols in an order from the most recent to the least recent. The end device is then updated according to the most recent communication protocol in the list and being used by one of the controller devices.

A method for updating a system comprising an end device and a controller device that belong to a local communication network managed by the controller device is also proposed here. The end device communicates with the controller device via a current communication protocol, the method comprising:
updating the end device by downloading a first part of another communication protocol different from the current communication protocol,
triggering an execution of the update management method as described previously, so as to trigger the phase of discovery by the end device;
updating the controller device by downloading the complete version of said other communication protocol, so that the controller device responds to said probe messages received from the end device during the phase of discovery by the end device.

An end device intended to belong to a local communication network managed by a controller device is also proposed here, the end device being configured to communicate with the controller device via a current communication protocol. This end device comprises electronic circuitry configured for:
storing in memory a first part of another communication protocol different from the current communication protocol,
executing a discovery phase during which the end device uses said first part for:
sending, to the controller device, at least one probe message specific to said other communication protocol,
awaiting at least one response message responding to the at least one probe message sent, coming from the controller device,
checking whether at least one said response message is received and then downloading a second part of said other communication protocol, complementary to said first part, so as to have available a complete version of said other communication protocol,
executing a phase of updating the end device comprising: replacing, in the end device, the current communication protocol with said other communication protocol as a new current communication protocol.

A computer program product is also proposed here, comprising instructions causing the execution, by a processor, of the update management method as described above, when said instructions are executed by the processor.

A storage medium is also proposed here, storing a computer program comprising instructions causing the execution, by a processor, of the update management method as described above, when said instructions are executed by the processor.

### BRIEF DESCRIPTION OF THE DRAWINGS

The features of the embodiments mentioned above, as well as others, will emerge more clearly from the reading of the following description of at least one example embodiment, said description being made in relation to the accompanying drawings, among which:

FIG. 1 illustrates schematically an example of implementation environment of the method for managing updating of an end device, according to a particular embodiment;

FIG. 2 illustrates in diagram form a method for managing updating of an end device according to one embodiment;

FIG. 3A illustrates schematically an example of exchanges between an end device and a controller device during the implementation of the method for managing updating of the end device, according to one embodiment,

FIG. 3B illustrates schematically another example of exchanges between an end device and a controller device during the implementation of the method for managing updating of the end device, according to one embodiment,

FIG. 4 illustrates schematically the hardware architecture of an end device configured to perform all or some of the steps of the management method illustrated in FIGS. 2 and 3.

### DETAILED DISCLOSURE OF EMBODIMENTS

The general principle of one or other of the embodiments relates to updating the communication protocol of an end device (i.e. access point or user device) following the establishment of a new communication protocol in the local communication network LAN.

The change of communication protocol in the local communication network may originate from:
an update of the communication protocol (e.g. updating the protocol stack of the controller device) currently used by the controller device managing the local communication network LAN (for example: changing to a communication protocol according to a more recent standard, changing to a solution for managing the mesh network of a different provider),
installing a new controller device in the local communication network LAN. This new controller device uses a more recent communication protocol than the one currently used in the local communication network (i.e. the communication protocol of the old controller device).

In particular, the present disclosure relates to the storage and use of a specific first part of this new communication protocol, prior to the implementation of this new communication protocol in its complete version in the end device. The use of this specific first part of the new communication device corresponds to a discovery function of the latter. This discovery function makes it possible, during a discovery phase, to detect that this new communication protocol is used in the local communication network LAN. By virtue of this first part of the new communication protocol, the end device can, where applicable, download a second part complementary to the first part of the new communication protocol for use of a complete version thereof.

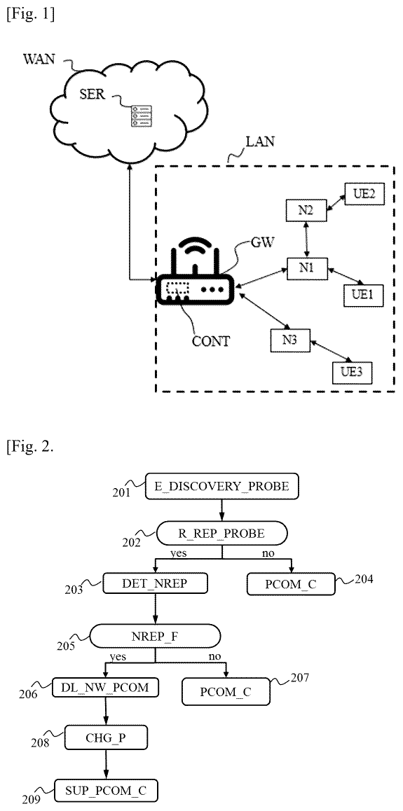

FIG. 1 thus illustrates schematically an example of implementation environment of the method for managing updating of an end device according to a particular embodiment.

The local communication network LAN comprises a gateway, denoted GW, for access to a wide area network WAN, for example an internet network. The gateway GW is connected to the wide area network WAN by an ADSL or fibre connection. Naturally it can also connect to a cellular network of an operator by a radio wireless connection of the 2G to 5G type.

In the embodiment in relation to FIG. 1, the local communication network LAN is a Wi-Fi network of the mesh type. For this purpose, this local communication network LAN comprises, for example, a system for extension of wireless-communication coverage coordinating a plurality of access points integrated in communication nodes denoted N1, N2 and N3. These various access points are interconnected by means of a backhaul subnetwork. These access points all allow access to the local communication network LAN for user devices denoted UE1, UE2, UE3. The access points N1, N2 and N3 can be connected to the gateway GW by cable connection or by wireless connection for access to the wide area network WAN.

In general, in the case of a wireless network of the mesh type, each communication node N1, N2 and N3 of the backhaul subnetwork comprises a plurality of access points on one and the same radio:
a so-called “AP-BH” (standing for “Access Point Backhaul”) access-point interface corresponding to an access-point interface of the backhaul subnetwork,
an “STA-BH” (standing for “Station Backhaul”) access-point interface corresponding to a user (or client) access-point interface of the backhaul subnetwork,
an “AP-FH (standing for “Access Point Fronthaul”) access-point interface corresponding to an access-point interface of the local communication network LAN, this interface being dedicated to associating user devices UE1, UE2, UE3 with the local communication network LAN.

The communication nodes N1, N2 and N3 of the backhaul subnetwork are connected to one another by means of a mesh structure in tree form, a node then being able to serve as relay between two other nodes of the backhaul subnetwork. The communication nodes N1, N2 and N3 are thus interconnected by means of cable connections, for example of the Ethernet type, and/or wireless connections. The communication nodes N1, N2 and N3 of the backhaul subnetwork thus communicate with each other by means of logic links, for example IP communications or encrypted tunnels or communications in accordance with a proprietary communication protocol. In one example, the node N1 is connected to the node N2 by means of a wireless connection between the access-point radio interface AP-BH of the node N1 and the client radio interface ST-BH of the node N2. The connections between two nodes of the backhaul subnetwork are called backhaul connections and can be cable or wireless.

Where applicable, the user devices UE1, UE2, UE3 can be connected to the various nodes N1 to N3 via their radio interface AP-FH for access thereof to the local communication network LAN.

This local communication network LAN therefore also comprises all the user devices UE1, UE2, UE3 such as a TV set-top box, a personal computer, a tablet, etc. These user devices UE1, UE2, UE3 can be connected directly to the gateway GW or via one of the access points located in the communication nodes N1, N2 or N3 (as shown on FIG. 1). The connection with the gateway GW or the access points located in the communication nodes N1, N2, N3 can be done by cable connection (for example of the Ethernet type), or by other types of connection such as for example USB, wireless connection, for example of the type: Wi-Fi, Bluetooth, Bluetooth Low Energy, Zwave, Zigbee, DECT-ULE, etc.).

Hereinafter, the user devices UE1, UE2, UE3 and the access points located in the communication nodes N1, N2, N3 are called end devices 400. An example of an implementation of such an end device 400 is shown below in relation to FIG. 4. These end devices 400 are able to connect to the local communication network LAN in that they have authorisations and configurations necessary for accessing the resources of said local communication network LAN.

The local communication network LAN of FIG. 1 also comprises a controller device CONT managing said network. In the embodiment according to FIG. 1, the controller device CONT is located in the gateway GW. In this case, the gateway GW not only provides access to the wide area network WAN, but also manages the communication network LAN via the controller device CONT.

In a variant, the controller device CONT is an electronic device independent of the gateway GW. In this case, the controller device CONT manages the local communication network LAN and the gateway GW provides access to the wide area network for the end devices 400 and the controller device CONT. It should be noted that the end devices 400 can, alternatively or additionally, access the wide area network via other equipment, such as for example a USB key providing access to the wide area network (for example 4G key).

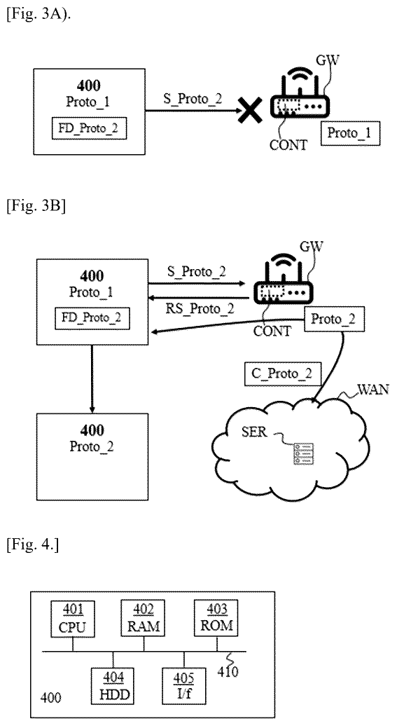

All or part of the method for managing an update of an end device 400 as described below in relation to FIG. 2 and FIGS. 3A and 3B is implemented by an end device 400 described below in relation to FIG. 4.

In order to illustrate the implementation of the method for managing updating an end device 400, it is considered that said end device 400 is for example an access point of the wireless extender type.

FIG. 2 illustrates in diagram form a method for managing updating of an end device 400 according to a particular embodiment.

FIG. 3A illustrates schematically an example of exchanges between: an end device 400 and a controller device CONT located in the gateway GW, during the implementation of the management method according to a particular embodiment.

FIG. 3B illustrates schematically another example of exchanges between: an end device 400 and a controller device CONT located in the gateway GW, during the implementation of the management method according to a particular embodiment.

It is considered here that the controller device CONT currently uses a first communication protocol, denoted Proto_1, and therefore requires the use of this communication protocol Proto_1 in the local communication network LAN. The end device 400 therefore uses this first communication protocol Proto_1 in order to be able to fully communicate in the communication network LAN and access the wide area network WAN, in which case via the gateway GW.

In order to be in a position to detect a change of communication protocol in the local communication network LAN, the end device 400 stores in memory and also implements a specific first part FD_Proto_2 of a second communication protocol Proto_2, different from the first communication protocol Proto_1. It should be noted that this second communication protocol Proto_2 may be a more recent communication protocol than the first communication protocol Proto_1. Thus, hereinafter, the second communication protocol Proto_2 is also called the new communication protocol, and the first communication protocol Proto_1 is also called the old communication protocol or current communication protocol.

This specific first part FD_Proto_2 of the second communication protocol Proto_2 is implemented in addition to the implementation of the native functions of the end device 400. In other words, the various steps of the update-management method as described below are performed in parallel to the native functions of the end device 400.

This specific part FD_Proto_2 of this second communication protocol Proto_2 corresponds to a discovery function of this second communication protocol Proto_2. Hereinafter, the specific first part of the second communication protocol Proto_2, different from the first communication protocol Proto_1 currently used by the controller device CONT managing the local communication network LAN, is termed “discovery function”. This discovery function makes it possible to discover, or detect, the use, in the local communication network LAN, of the corresponding communication protocol. In this case, the discovery function FD_Proto_2 makes it possible to discover, or detect, the use of the second communication protocol Proto_2 in the local communication network LAN. In particular, this discovery function FD_Proto_2 comprises:
a module configured to send a probe message S_Proto_2 that can be interpreted by the controller device CONT using the second communication protocol Proto_2;
a module configured to interpret a message RS_Proto_2 of response to the probe message S_Proto_2 sent from the controller device CONT (especially when the latter has changed to the second communication protocol Proto_2);
a module configured to download, from a dedicated server SER, via the wide area network WAN, a complementary second part C_Proto_2 of the second communication protocol Proto_2, so that a complete version of the latter can be implemented in the end device 400.

This discovery function FD_Proto_2 is simple in its operation in that it comprises only the modules described above. This makes it possible to optimise the storage space of the end device 400. The memory footprint of the discovery function is therefore smaller than if the end device 400 were to incorporate the whole of the communication protocol Proto_2.

Thus, in one embodiment, the end device 400 can store and implement a plurality of discovery functions specific to various communication protocols more recent than the one currently being used in the local communication network LAN.

In one example, an end device 400 natively compatible with a proprietary communication protocol stores in memory and implements the discovery function of a proprietary communication protocol of another provider.

It should be noted that this discovery function is particular to a particular communication protocol. In other words, the specificities of the new communication protocol to be discovered (for example the communication protocol Proto_2 in the example in relation to FIGS. 3A and 3B) have an impact on the type of discovery function. In other words, to each communication protocol there corresponds a corresponding discovery function.

Consequently, in order to discover a new communication protocol used in the local communication network LAN (e.g. second communication protocol Proto_2), the end device 400 must incorporate the corresponding discovery function (e.g. the discovery function FD_Proto_2 of the second communication protocol Proto_2), before the new communication protocol is installed in the local communication network LAN. This is because, in the case of incompatibility between the communication protocols of the end device 400 and of the controller device CONT, the end device 400 can no longer access the local communication network LAN, or the wide area network WAN.

In the case of an end device 400 already present in the local communication network LAN, it is possible for the latter not to natively incorporate the discovery function of the new communication protocol (for example because this new communication protocol may not exist at the moment of deployment of this end device 400). Then, in this case, an update of the end device 400 is necessary in order for it to incorporate the discovery function of the new communication protocol. In other words, prior to the installation of the new communication protocol in the local communication network LAN, i.e. before the updating of the protocol stack of the controller device CONT or before the addition of a new more recent controller device CONT), a software update of the end device 400 is performed so that it incorporates the discovery function associated with the new communication protocol. This software update of the end device 400 makes it possible to anticipate the installation of a new communication protocol in the local communication network LAN. The anticipation of the updating of the discovery function enables the end device 400 to always be able to connect, even in a restricted manner, to the local communication network LAN in order to be able to access the wide area network WAN (for example via the controller device CONT providing access to the wide area network WAN). The end device 400, by virtue of this discovery function (and in particular by virtue of the module configured for downloading) can access a server SER of a service provider for downloading the complementary second part of the new communication protocol associated with the discovery function used, for implementing the complete version of this new communication protocol.

Once the end device 400 is updated to incorporate the discovery function FD_Proto_2, it can perform the steps described in relation to FIGS. 2 and 3A and 3B for discovering a new communication protocol Proto_2 used in the local communication network LAN and updating its protocol stack where applicable.

In the course of a step 201, a probe message S_Proto_2, specific to the second communication protocol Proto_2, is sent by the end device 400 to the control device CONT. More particularly, the probe message S_Proto_2 is sent by the end device 400 in a frame characteristic of the transmission mode of the probe message S_Proto_2. In one embodiment, the probe message S_Proto_2 is sent repeatedly.

In one example embodiment, when the end device 400 is connected to the local communication network LAN via an Ethernet connection, then this probe message S_Proto_2 is encapsulated in a frame of the Ethernet protocol. In another example embodiment, when the end device 400 is connected to the local communication network LAN by Wi-Fi, then the probe message S_Proto_2 is encapsulated in a frame of the 802.11/Wi-Fi protocol.

In one example embodiment, when the discovery function is specific to a communication protocol according to the EasyMesh standard, this probe message S_Proto_2 is a message of the “1905 AP-Autoconfiguration Search” type (for example in compliance with paragraph 6.1 of the Wi-Fi Alliance specification, or “WFA”, EasyMesh R3).

This probe message S_Proto_2 is only interpretable by the control device CONT when the latter uses, at the moment of reception of the probe message S_Proto_2, the second communication protocol Proto_2. In the contrary case, if the control device CONT is still using the first protocol Proto_1, then the probe message S_Proto_2 will not be able to be interpreted by the control device CONT (FIG. 3A).

In one embodiment, so that this probe message S_Proto_2 can optionally be detected by the controller device CONT in the whole of the communication network LAN, the terminal device 400 sends the probe message S_Proto_2 in a broadcast transmission. It is thus possible, unlike a unicast transmission, to address all the devices (end devices and controller devices) in the local communication network LAN and to be sure that one or more controller devices receive this probe message S_Proto_2.

In one example embodiment, when the end device 400 is a wireless extender, this transmission is done on each of its interfaces that can be connected to controller devices in the communication network LAN. In this case, the interfaces that can be connected are generally Ethernet interfaces, the AP-BH radio interface or the STA-BH radio interface.

In one embodiment, the probe message S_Proto_2 is transmitted in the course of the period during which the end device 400 does not execute a native function.

In another embodiment, the probe message S_Proto_2 is transmitted periodically, i.e. the probe message S_Proto_2 is sent repeatedly, at a predefined transmission frequency F. It is thus possible to detect (or discover) the use of the second communication protocol Proto_2 by the controller device CONT. This is because, when the controller device CONT has changed to another communication protocol, then the management of the local communication network LAN is interrupted since the end device 400 (e.g. wireless extender) and the controller device CONT are each using different protocols, in other words they are no longer speaking the same language. Thus the frequency F of transmission of the probe message S_Proto_2 must be carefully selected so that on the one hand the interruption of service suffered by the user due to incompatibility between the first communication protocol Proto_1 normally used by the end device 400 and the second/new communication protocol Proto_2 used by the controller device CONT is not too long. On the other hand, the frequency F of transmission of the probe message S_Proto_2 must not be too short since sending the probe message S_Proto_2 with an excessively high frequency could disturb the other native functions of the end device 400, as well as causing an additional load due to the transmissions of the probe message S_Proto_2 over the communication network LAN.

Thus, in one embodiment, the frequency F of transmission of the probe message S_Proto_2 does not exceed 5 minutes in order to make the interruption of service acceptable to the user and is not less than one second in order not to degrade the performances of the local communication network LAN. In one embodiment, the probe message S_Proto_2 is sent every 5 minutes.

During a step 202, denoted R_REP_PROBE, the end device 400 awaits a response message RS_Proto_2 following the sending of the probe message S_Proto_2.

As mentioned previously and presented in relation to FIG. 3A, if the controller device CONT is not yet using the second communication protocol Proto_2 specific to the probe message S_Proto_2, then no response message RS_Proto_2 is transmitted (step 202, result “no”) from the controller device CONT to the end device 400. In this case, during the step 204, denoted PCOM_C, the end device 400 and the controller device CONT continue to use the first communication protocol Proto_1 for their exchanges in the local communication network LAN.

On the other hand, as presented in relation to FIG. 3B, if the communication protocol used by the control device CONT has changed to the second communication protocol Proto_2, then the latter sends to the end device 400 a response message RS_Proto_2. In other words, when the controller device CONT is updated by downloading the complete version of the second communication protocol Proto_2, then the controller device CONT can interpret the probe message S_Proto_2 sent by the end device 400 and send to the end device 400 a response message RS_Proto_2 during the discovery phase implemented by the end device 400.

For example, when the controller device CONT is using a communication protocol according to the EasyMesh standard, the response message RS_Proto_2 sent by the controller device CONT is of the “1905 AP-Autoconfiguration Response” type.

In this case, during this step 202 R_REP_PROBE, the end device 400 checks whether it receives a response message RS_Proto_2 coming from the controller device CONT. By virtue of the discovery function FD_Proto_2, the end device 400 is able to interpret this response message RS_Proto_2.

If the end device 400 receives a response message RS_Proto_2 (step 202, result “yes”), following the sending of the probe message S_Proto_2, then the second communication protocol Proto_2 is used by the controller device CONT and is therefore supported by the local communication network LAN.

During an optional step 203, denoted DET_NREP, the end device 400 determines, over a predetermined period P, a number of response messages RS_Proto_2 received following the sending of the successive probe messages S_Proto_2 during the predefined period P. In other words, the end device 400 determines whether, for each probe message S_Proto_2, it receives a response message RS_Proto_2 in return over the predefined period P. The end device 400 next counts the number of response messages RS_Proto_2 received over the predefined period P.

In one embodiment, the predefined period P depends on the frequency F of sending the probe message S_Proto_2. In one embodiment, this period P is between 5 seconds and 5 minutes.

At the end of the step 203 DET_NREP, the end device 400 determines whether the number of response messages RS_Proto_2 received during the predefined period P is reliable. More particularly, during an optional step 205, denoted NREP_F, the end device 400 determines whether the number of response messages RS_Proto_2 is greater than or equal to a predefined response-message reliability threshold S. It is thus possible not to take account of intermittent changes in communication protocol that may occur when the new controller device CONT is installed in the local communication network LAN. In one example embodiment, a response message RS_Proto_2 is considered to be reliable if the end device 400 receives at least four responses out of five transmissions of probe messages S_Proto_2.

Thus, at the end of the optional step 205 NREP_F, if the number of response messages RS_Proto_2 received is greater than or equal to the reliability threshold S (step 205, result “yes”), then the end device 400 considers that the second communication protocol Proto_2 is being used in the local communication network LAN (i.e. the controller device CONT is using the second communication protocol Proto_2 corresponding to the discovery function used FD_Proto_2). On the other hand, (step 205, result “no”), if the number of response messages RS_Proto_2 received is insufficient (i.e. below the reliability threshold S), then the end device 400 considers that the second communication protocol Proto_2 corresponding to the discovery function FD_Proto_2 is not being used by the controller device CONT and the downloading procedure described below is not triggered. In this case, during the step 207, denoted PCOM_C, the end device 400 and the controller device CONT continue to use the first communication protocol Proto_1 for their exchanges in the local communication network LAN. Optionally, at the end of the step 207 PCOM_C, the end device 400 begins a new cycle of discovering or detecting the second communication protocol Proto_2 by means of its discovery function FD_Proto_2.

Thus, if the number of response messages RS_Proto_2 received is greater than or equal to the reliability threshold S (step 205, result “yes”), then the end device 400 performs the optional step 206 DL_NW_PCOM. During this step 206, DL_NW_PCOM, the end device 400 uses the discovery function FD_Proto_2 to access the wide area network WAN to download the complementary second part C_Proto_2 of the second communication protocol Proto_2 specific to the discovery function FD_Proto_2. For this purpose, the end device 400 downloads this second complementary part C_Proto_2 from a dedicated server SER.

In one example embodiment, the end device 400 can be updated by downloading according to a transmission protocol of the HTTPS type (“Hyper Text Transfer Protocol Secure”) from a URL address (standing for “Uniform Resource Locator”) pre-entered in the memory of the end device 400. The URL must be different from the one used for a conventional update without change in the protocol stack of the end device 400. The end device 400 changes this URL on its own initiative.

In another example embodiment, the updating of the end device 400 and, in particular, the downloading of the complementary part of the new communication protocol can also be implemented by the TR-069 protocol. The TR-069 protocol (“Technical Report” or CWMP, standing for “CPE WAN Management Protocol”) is a protocol defined for managing communication between equipment in a local area network of the user and a remote autoconfiguration server accessible via a wide area network WAN. In this case, a URL address for version downloading is provided by a server SER, which is for example an ACS server (standing for “Automatic Configuration Server”). The end device (for example a wireless extender) cannot therefore differentiate the URL address for a conventional update from the one for a change in communication protocol (for example a communication protocol in accordance with the EasyMesh standard). The end device 400 (e.g. wireless extender) will therefore indicate a change in protocol by a TR-69 notification called “inform value change”. The name of the new communication protocol detected must be present in the so-called “data model” field and, when the value of this field changes, then the end device 400 sends the notification for informing the ACS server that an update is desirable.

At the end of the discovery phase comprising the steps 201 to 207, the end device 400 implements a phase of updating its current communication protocol.

During a step 208, denoted CHG_P, the end device 400 then implements a phase of updating its communication protocol or protocol stack. In particular, the end device 400 replaces the old communication protocol (i.e. first communication protocol Proto_1) with the new communication protocol (i.e. second communication protocol Proto_2). The end device 400 can then fully use the new communication protocol Proto_2 in its complete version.

During a step 209, denoted SUP_PCOM_C, the end device 400 deletes the old communication protocol (i.e. first communication protocol Proto_1), which has become obsolete. It is thus possible to optimise the storage space by keeping only the communication protocol, for example the most recent, used in the local communication network LAN.

In a particular embodiment, it may happen that several controller devices are present in the local communication network. This is the case for example when a new controller device is added to the local communication network LAN, with a view, for example, to replacing the one currently present. These controller devices then implement different communication protocols. In particular, one of the controller devices implements a more recent communication protocol than the other controller device. In this case, the end device 400 implements several discovery functions associated with these various communication protocols. The end device 400 then detects several different communication protocols. Determining the “dominant” communication protocol consists in selecting the most recent communication protocol among all the communication protocols used by the various controller devices. For this purpose, the end device 400 comprises in memory a list of the communication protocols classified from the most recent to the least recent with, for each communication protocol, the discovery function that relates thereto. The end device 400 then attempts to discover each communication protocol in the order of this list. In other words, the end device 400 implements first the discovery function of the most recent communication protocol. The downloading procedure is then triggered for the most recent communication protocol among all the communication protocols used by the controller devices.

FIG. 4 illustrates schematically the hardware architecture of an end device 400 configured to perform all or some of the steps of the management method illustrated in FIGS. 2 et 3A et 3B.

The end device 400 comprises, connected by a communication bus 410: a processor or CPU (“central processing unit”) 401; a random access memory (RAM) 402; a read only memory (ROM) 403, for example a flash memory; a data storage device such as a hard disk drive HDD, or a storage medium reader, such as an SD (Secure Digital) card reader 404; at least one communication interface I/f 405 enabling the end device 400 to interact with the other end devices in the local communication network LAN, as well as with the controller device CONT.

The processor 401 is capable of executing instructions loaded in the RAM 402 from the ROM 403, from an external memory (not shown), from the data storage device 404, such as an SD card, or from a communication network (not shown). When the end device 400 is powered up, the processor 401 is capable of reading instructions from the RAM 402 and executing them. These instructions form a computer program causing the implementation, by the processor 401, of the behaviours, steps and algorithms described here, in particular in combination with all or some of the steps of FIGS. 2 et 3A et 3B.

All or some of the behaviours, steps and algorithms described here can thus be implemented in software form by executing a set of instructions by a programmable machine, such as a DSP (“digital signal processor”) or a microcontroller, or be implemented in hardware form by a machine or a dedicated component (chip) or a set of components (chipset), such as an FPGA (field-programmable gate array) or an ASIC (application-specific integrated circuit). In general terms, the end device 400 comprises electronic circuitry arranged and configured to implement the behaviours, steps and algorithms described here.

It should be noted furthermore that the term “module” can correspond both to a software component and to a hardware component or a set of hardware and software components, a software component itself corresponding to one or more computer programs or subprograms or in more general terms to any element of a program able to implement a function or a set of functions.

1. A method for managing an update of an end device belonging to a local communication network managed by a controller device, the end device communicating with the controller device via a current communication protocol, the method being implemented by the end device, and comprising:
storing in memory a first part of another communication protocol different from the current communication protocol,
executing a discovery phase during which the end device uses said first part for:
sending, to the controller device, at least one probe message specific to said other communication protocol,
awaiting at least one response message responding to the at least one probe message sent, coming from the controller device,
checking whether at least one said response message is received and then downloading a second part of said other communication protocol, complementary to said first part, so as to have available a complete version of said other communication protocol, and
executing a phase of updating the end device comprising: replacing, in the end device, the current communication protocol with said other communication protocol as a new current communication protocol.

2. The method according to claim 1, wherein the phase of updating the end device furthermore comprises deleting from the end device the current communication protocol that has become obsolete.

3. The method according to claim 1, wherein the probe message is sent repeatedly and the second part of the other communication protocol, complementary to the first part, is downloaded if, over a predefined period, a number of response messages received is greater than or equal to a predefined reliability threshold.

4. The method according to claim 1, wherein the probe message sent is sent in a broadcast transmission.

5. The method according to claim 1, wherein the probe message sent is sent at a predefined transmission frequency.

6. The method according to claim 5, wherein the predefined transmission frequency is between 1 second and 5 minutes.

7. The method according to claim 1, furthermore comprising storing in memory a list of a plurality of other communication protocols, different from the current communication protocol, said other communication protocols being classified in an order of communication protocol from the most recent to the least recent, and, for each other communication protocol in the list, storing in memory a first part of said other communication protocol in question,
and wherein the discovery phase, during which the first part of each said other communication protocol is used, is executed in the order of said list.

8. The method for updating a system comprising an end device and a controller device that belong to a local communication network managed by the controller device, the end device communicating with the controller device via a current communication protocol, the method comprising:
updating the end device by downloading a first part of another communication protocol different from the current communication protocol,
triggering an execution of the update management method according to claim 1, so as to trigger the phase of discovery by the end device;
updating the controller device by downloading the complete version of said other communication protocol, so that the controller device responds to said probe messages received from the end device during the phase of discovery by the end device.

9. An end device intended to belong to a local communication network managed by a controller device, the end device being configured to communicate with the controller device via a current communication protocol, said end device comprising electronic circuitry configured for:
storing in memory a first part of another communication protocol different from the current communication protocol,
executing a discovery phase during which the end device uses said first part for:
sending, to the controller device, at least one probe message specific to said other communication protocol,
awaiting at least one response message responding to the at least one probe message sent, coming from the controller device,
checking whether at least one said response message is received and then downloading a second part of said other communication protocol, complementary to said first part, so as to have available a complete version of said other communication protocol,
executing a phase of updating the end device comprising: replacing, in the end device, the current communication protocol with said other communication protocol as a new current communication protocol.

10. (canceled)

11. A non-transitory storage medium; storing a program product comprising program code instructions causing implementation, by a processor, of the method according to claim 1, when said instructions are executed by the processor.
